(19) United States
(12) Patent Application Publication
(10) Pub. No.: US 2016/0165844 A1
(43) Pub. Date: Jun. 16, 2016

(54) PET TOY WITH BRAIDED EXTERIOR AND FLEXIBLE CORE

(71) Applicant: The KONG Company, LLC, Golden, CO (US)

(72) Inventor: Hoyt Samuel Nunn, Irvine, CA (US)

(21) Appl. No.: 14/566,903

(22) Filed: Dec. 11, 2014

(51) Int. Cl. A01K 15/02; A01K 29/00

(52) U.S. Cl. CPC A01K 15/025; A01K 29/00

(57) ABSTRACT

The invention is a pet toy with a braided exterior and a flexible core. In one preferred embodiment, the flexible core has an elongated shape and a generally tubular configuration with a hollow interior or chamber. The flexible core is covered with a braided material that may be selected from a resilient and relatively strong fabric material. A noisemaking device or “squeaker” may be incorporated within the pet toy in a protected configuration thereby making it difficult for an animal to gain access to the squeaker. The squeaker can be embedded in one end of the flexible core, and may be fully or partially encapsulated by the core material thereby providing additional protection for the squeaker, yet enabling the squeaker to function in order to produce sound. According to another aspect of the invention, a braiding technique provides an aesthetically pleasing yet functional covering for the flexible core.

### FIELD OF THE INVENTION

The invention relates to pet toys, and more particularly, to pet toys having an exterior made from a braided cloth or fabric material and a flexible thermoplastic elastomer or thermoplastic rubber core covered by the braided material.

### BACKGROUND OF THE INVENTION

Pet toys are made from many different types of materials. One general category of pet toys is those made of a flexible or elastomeric material, such as rubber. These toys, if made from quality materials, can withstand the biting action of an animal, and can keep the animal occupied for a period of time. It is known to place treats in these types of toys to increase the interaction of the animal with the toy. A sound emitting device, often referred to as a “squeaker”, is also known to be placed inside the toy to further stimulate the animal.

Another general category of pet toys are those which may generally be referred to as “plush” toys. These types of toys are made from different types of cloth or fabric, and may also include material woven into strands, such as nylon rope. Some animals may prefer a plush toy as compared to a rubber toy, and a pet owner must often experiment with various types of pet toys to determine the types of pet toys that may best induce or encourage interaction with the animal. Plush toys may also include squeakers to further stimulate the animal.

One drawback associated with both traditional rubber pet toys and plush toys is that an animal will often bite on the toy for the primary purpose of obtaining access to the squeaker, to disable or “kill” the squeaker according to natural instincts of the animal. Therefore, an animal may work particularly hard to the bite and tear open the pet toy to access the squeaker, which compromises the overall life of the pet toy, and may in some cases endanger the animal by the animal ingesting pieces of the pet toy and/or the squeaker device.

Particularly for plush toys, it is very difficult to adequately protect the squeaker from being exposed by the biting action of the animal due to the materials of the plush toy being susceptible to tearing and failure. For a considerable percentage of plastic or rubber toys, these may not be made of quality materials, thus the animal is able to tear or break the toy without significant difficulty.

Considering the general defects in the prior art mentioned above, there is a need for a pet toy that may adequately protect a squeaker device, yet may still provide to the animal desirable characteristics that induce or incentivize the animal to interact with the pet toy. There is also a need for a pet toy that may combine features of both plush toys and flexible rubber/plastic toys which may therefore attract a greater percentage of animals, since many prefer only one or the other type of toy. There is also a need for a pet toy incorporating a squeaker device in which activation of the squeaker can be achieved with pressure applied to the toy at various locations on the toy, as opposed to one relatively small area.

The invention described below provides solutions to many defects in the prior art, yet with a pet toy construction that is robust enough to withstand the prolonged biting action of an animal. The invention also provides a pet toy that is relatively simple in structure, and therefore, can be produced at reasonable costs considering a pet toy market that continues to be more competitive in many countries.

### SUMMARY OF THE INVENTION

The invention is a pet toy with a braided exterior and a flexible core. In one preferred embodiment of the invention, the flexible core has an elongated shape and a generally tubular configuration with a hollow interior or chamber. The flexible core is covered with a braided material. The braided material may be selected from a resilient and relatively strong cloth or fabric. One example of a cloth/fabric material includes fleece. Alternatively, the braided material may be made from a cloth fiber material, such as a nylon rope.

In another aspect or feature of the preferred embodiment, the flexible core may correspond to the body or torso portion of a character depicted by the pet toy. For example, the flexible core may correspond to the body portion of a doll or an animal such as a giraffe. Appendages or other features may be sewn directly to the braided material in order for the pet toy to more accurately represent a depicted character. For example, if the pet toy is intended to represent a doll shape, features may be sewn to the braided material, such as arms, legs, a head, etc.

According to another feature of the preferred embodiment, a noisemaking device or “squeaker” is incorporated within the pet toy in a protected configuration thereby making it quite difficult for an animal to gain access to the squeaker. In the preferred embodiment, the squeaker is embedded in one end of the flexible core, and may be fully or partially encapsulated by the core material thereby providing additional protection for the squeaker, yet enabling the squeaker to function in order to produce sound.

The braided material is secured to the flexible core in a manner that provides both aesthetic and functional benefits. According to one braiding technique, the braid is created such that a series of aligned knots define the lateral side edges of the torso of the pet toy. The areas between the lateral side edges are covered with transverse overlapping or stacked pieces of braided material which thereby cover most or all of the exterior surface of the flexible core. Covering of the flexible core can be achieved with but two pieces of material according to the braiding technique of the invention.

According to the braiding technique, two lengths or strands of braiding material are placed side-by-side. A bite or turn is formed on both lengths of material. Interlocking loops are formed by crossing the free ends of the respective lengths of material in which the free end of one length is routed behind proximal portions of both lengths of material, and then through a loop formed in the other length of material. The free end of the other length is routed in front of proximal portions of both lengths of material, and then through another loop formed in the other length of material. The free ends of the lengths of material are pulled to reduce the size of the loops thereby forming a gap between the loops and the lower proximal portions of the lengths of material. Next, a single lower loop is formed in the gap between the existing pair of loops and the lower proximal portions of the material. The lower loop is formed by again crossing the free ends of the lengths of material in opposite directions in which one free end passes from front to rear through the lower loop, and the other free end passes under the other free end and then between the lower proximal portions of the lengths of material. The free ends of the material are pulled to further tighten the arrangement of strands to create a braided element that traverses across the flexible core including two new knots and corresponding traversing sections on each opposite side of the flexible core. Another braided element can be formed by repeating the same braiding technique with the remaining portions of the lengths of braiding material. A number of braided elements may be formed to cover the entire length of the flexible core or selected portions thereof.

In order to provide a further plush toy feature to the invention, the flexible core may be first covered with a layer of fabric material, similar to a pillow case covering, in which one end of the fabric material is open to receive the flexible core, and then is sewn shut to completely cover the flexible core. Then, the braiding material may be secured over the fabric material covering.

In accordance with one aspect of the invention, it may be considered a pet toy comprising: (i) a flexible and resilient core having an interior space defining a chamber; (ii) a noise making device disposed within the core; (iii) a braided material covering the flexible core, the braided material including a plurality of knots and a plurality of traversing sections extending between the plurality of knots; and (iv) at least one exterior feature secured to the braided material.

In accordance with another aspect of the invention, it may be considered a pet toy comprising: (i) a flexible and resilient core having an interior space defining a chamber; (ii) a noise making device disposed within the core: (iii) a braided material covering the flexible core, the braided material including a plurality of knots and a plurality of traversing sections extending between the plurality of knots; and wherein the noisemaking device is disposed within the core at one end thereof, and is at least partially encapsulated by material of the core at the one end, thereby providing protection for the noisemaking device from a biting action of an animal.

According to either or both of the above aspects, further features of the invention may include:

(i) the core is made of a thermoplastic elastomer or thermoplastic rubber that is flexible and resilient in response to a biting action from an animal on the core; (ii) the chamber defines a substantially cylindrical shaped opening through the core; (iii) the chamber has a substantially elliptical cross sectional shape; (iv) an opening is formed within the core, and the opening communicates with the noisemaking device enabling a flow of air into and out from the chamber thereby enabling the noisemaking device to create sound as air also passes through the noisemaking device; (v) the core extends along a longitudinal axis of the pet toy, the core having a length extending with the longitudinal axis, and further having a width extending transverse to the longitudinal axis (vi) lateral side edges of the core extend along the longitudinal axis and substantially parallel to one another, and opposite ends of the core extend substantially perpendicular to the lateral side edges and along the with (vii) the plurality of knots are oriented and aligned along both lateral side edges of the core, and the plurality of traversing sections extend between the plurality of knots transversely across the core along the width; (viii) the plurality of knots extends on lateral sides of the core in respective serial arrangements; (ix) the plurality of traversing sections extends transversely across the core between and substantially perpendicular to the lateral side edges; and (x) the braided material comprises two strands of fabric material braided along a length of the core to cover the core.

Other features and advantages of the invention will become apparent from a review of the following drawings taken in conjunction with the detailed description.

### BRIEF DESCRIPTION OF THE DRAWINGS

FIG. 1 is a front view of the pet toy of the invention in one preferred embodiment;

FIG. 2 is a perspective view of the flexible core with a squeaker disposed therein;

FIG. 2A is an enlarged portion of FIG. 2 showing further details on the squeaker disposed within one end of the flexible core;

FIG. 3 is a perspective view of the flexible core of FIG. 2 showing exterior braiding material covering a portion of the flexible core, such as during assembly/manufacturing of the pet toy; and

FIGS. 4-9 show two pieces or strands of braiding material in one preferred braiding technique or method for creating the pet toy with a braided exterior cloth or fabric material to cover the flexible core.

### DETAILED DESCRIPTION OF THE DRAWINGS

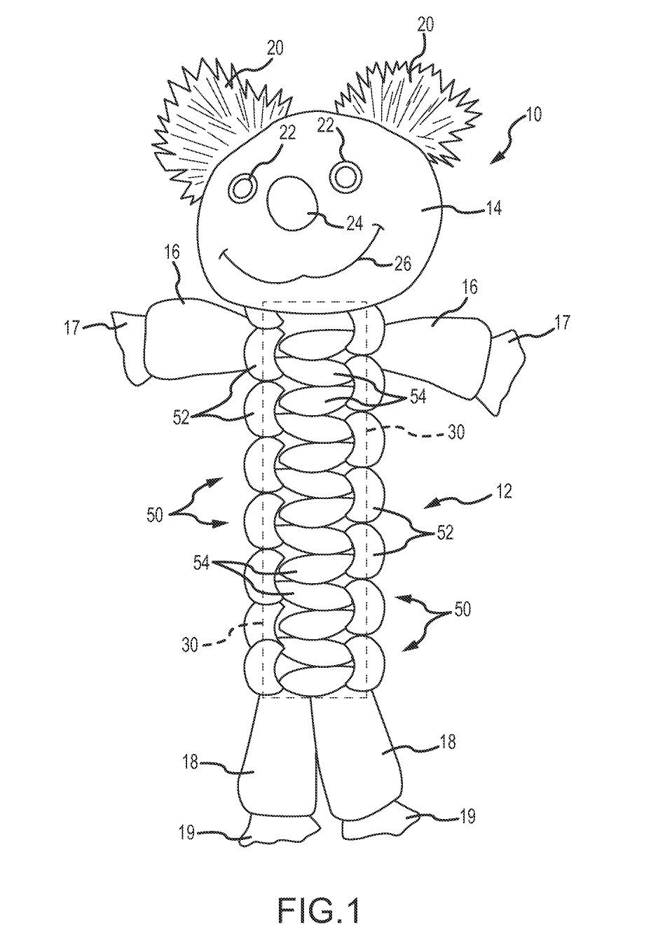

FIG. 1 illustrates the pet toy of the invention 10 in a preferred embodiment. Generally, the pet toy 10 depicts a doll-like figure in human form. The body or torso 12 of the pet toy is shown as a braided exterior with a head 14 and appendages attached to the body 12. As shown, the appendages include arms 16 with hands 17, and legs 18 with feet 19. Additional exterior features are illustrated on the head 14 including hair 20, eyes 22, a nose 24, and a mouth 26. These additional features on the head 14 may be constructed from different types of fabric sewn to the head 14, or can be made of other materials such as stitching, cut pieces of other fabric types, or other decorative items that might be used on dolls or plush toys. The term “fabric” as used herein is intended to cover all types of cloth material, as well as material that resembles cloth. While FIG. 1 illustrates a preferred embodiment with a head, appendages, and other features, it shall be understood that FIG. 1 is simply representative of one type of pet toy depiction, and the invention is intended to include other forms such as other doll-like figures, animals, and objects.

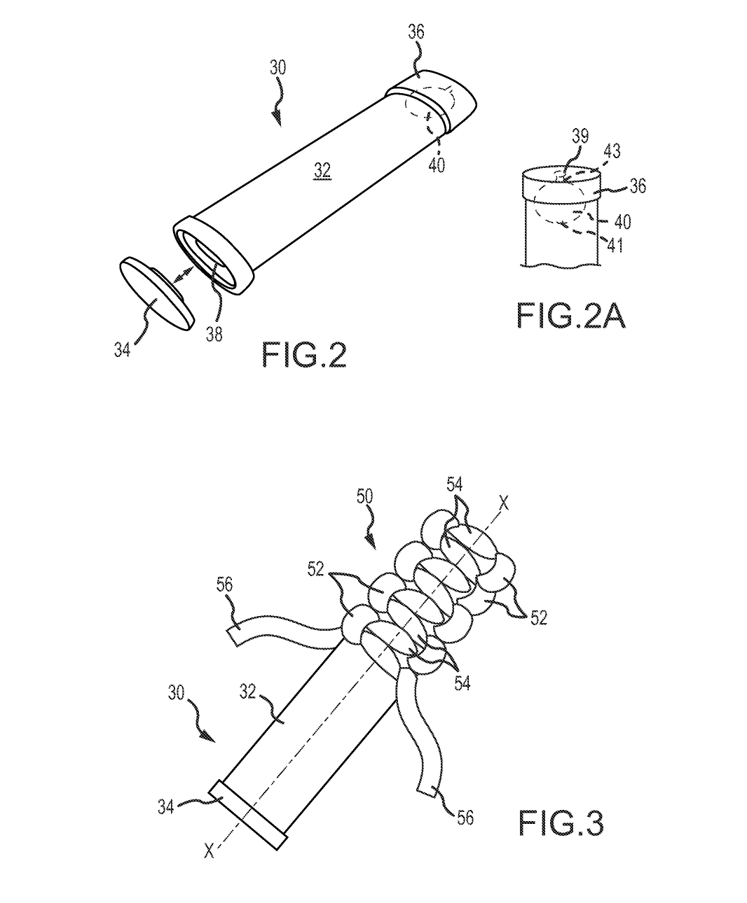

Referring to FIG. 2, the flexible core 30 is illustrated having a housing 32, a cap 34, and an end piece 36. The housing 32 is hollow, thereby defining an interior hollow space or chamber 38. The flexible core is made from a selected thermoplastic elastomer or thermoplastic rubber such that the flexible core can withstand the biting action of an animal. Specifically, the sidewalls of the housing 32 will deflect in response to the biting action which in turn, reduces the volume of air in the chamber 38. Also referring to FIG. 2A, the end of the housing 32 at the end piece 36 is shown in which a squeaker 40 is placed within the chamber of the housing, and is partially or completely encapsulated within the material of the flexible core to protect the squeaker 40. Air within the chamber communicates with an opening 41 formed on the base portion of the squeaker 40, and the nozzle or protrusion 43 of the squeaker communicates with an opening 39 formed on the end piece 36. Accordingly, as an animal bites and releases on the housing 32, air is allowed to flow out from and back into the chamber 38. As air flow occurs, air is forced through the squeaker 40, thereby causing a sound to be emitted by the squeaker 40. The squeaker 40 has a flexible housing with a reed disposed therein. The reed vibrates to create sound when air flows through the squeaker housing.

The flexible core 30 is depicted as having a generally elongated rectangular shape. The specific cross-sectional shape of the flexible core in the preferred embodiment of FIG. 2 is elliptical; however, it is contemplated that the particular shape of the flexible core could be more of a tubular shape in which the flexible core would therefore have a circular cross-section. One advantage of utilizing a flexible core 30 with an elongated shape is that there is an increased surface area for an animal to activate the squeaker, since the chamber of the flexible core can extend along a greater length of the pet toy.

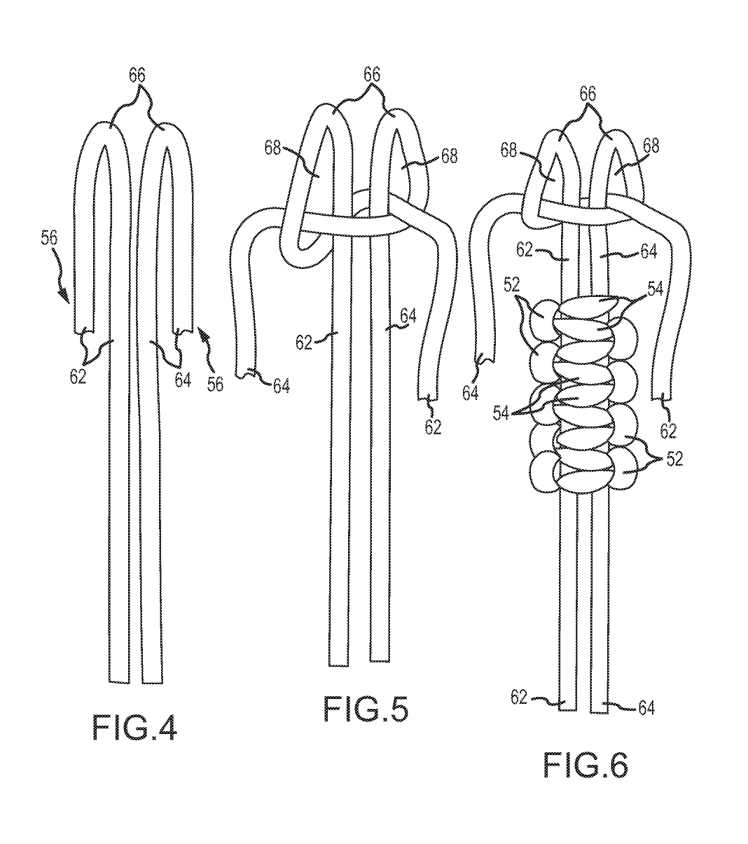

FIG. 3 generally illustrates a braided exterior 50 covering a portion of the flexible core, and the general orientation of the features of the braided exterior 50 with respect to the positioning of the flexible core 30. More specifically, the braided exterior 50 is generally symmetrical about a longitudinal axis x-x which extends along the length of the flexible core 30. The braided exterior includes two primary elements, namely, a plurality of knots 52 and a plurality of traversing sections 54. One group of knots 52 is aligned along one lateral side edge of the flexible core, while another group of knots 52 is aligned along the opposite lateral side edge of the flexible core. The plurality of traversing sections 54 extend between the groups of knots. Each group of knots 52 may also be defined as a plurality of knots extending along a lateral side of the flexible core in a serial arrangement. The traversing sections 54 cover the exterior surface of the flexible core between the groups of knots 52. When the braid is formed on the flexible core, the strands of fabric material used may be tightened and packed close enough to one another that all or nearly all of the surface area of the flexible core is covered with the fabric material. The braided pattern forming the braided exterior 50 is made by braiding the free or working ends 56 of the strands or lengths of fabric material, as explained further with respect to the FIGS. 4-9.

FIGS. 4-9 depict one preferred method of creating the braided exterior surface 50. Beginning with FIG. 4, two strands or lengths of fabric material 62 and 64 are shown. The free ends 56 of the material are manipulated to create the braided structure. Referring to FIG. 5, a bite or turn 66 is formed on both lengths of material. Interlocking loops 68 are formed by crossing the free ends of the respective lengths of material. More specifically, length 62 is formed with a loop 68, then the free end of the length 62 is routed behind proximal portions of both lengths of material, and then the free end passes through a loop formed in the other length of material, from rear to front according to the view in FIG. 5. Similarly, the length 64 is formed with a loop 68, but the free end of the length 64 is routed in front of proximal portions of both lengths of material, and then the free end passes through the loop formed in the other length of material, from front to rear according to the view in FIG. 5. Referring to FIG. 6, the free ends of the lengths of material 62 and 64 are pulled to reduce the size of the loops 68 thereby forming a gap between the loops 68 and the lower proximal portions of the lengths of material. In FIG. 6, a plurality of braided sections are also shown as being previously formed, including the characteristic groups of knots 52 and plurality of traversing sections.

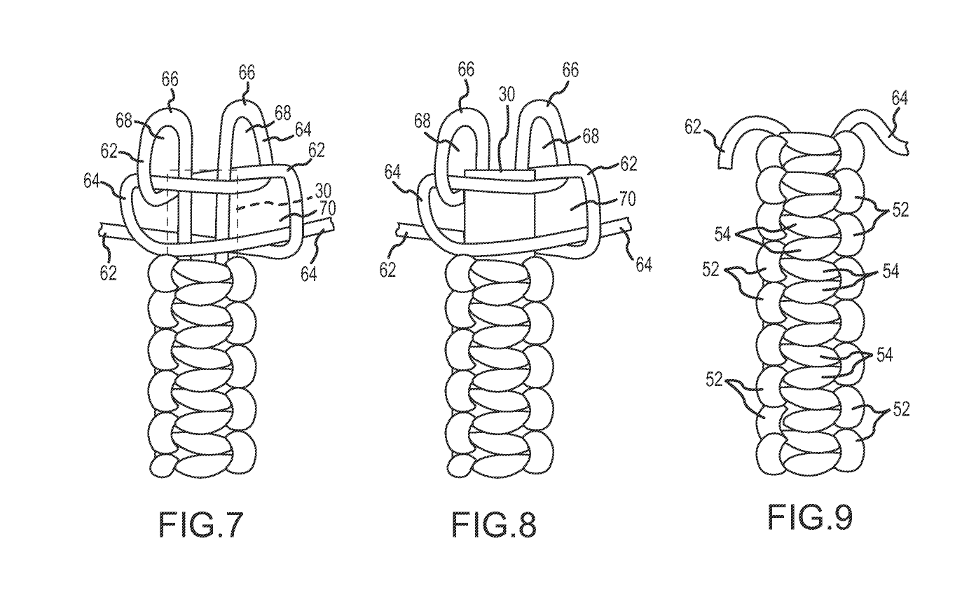

Referring to FIG. 7, a next step is to create a single lower loop 70 in the gap between the loops 68 and the lower proximal portions of the material, which in the case of FIG. 7, is located next to the previous braided element formed. The lower loop 70 is formed by again crossing the free ends of the lengths of material 62 and 64 in opposite directions in which one free end 64 passes from front to rear through the lower loop 70, and the other free end 62 passes under the other free end 64 and then between the substantially parallel proximal portions of the lengths of material. The free ends of the material lengths are then pulled to further tighten the arrangement of strands to create a braided element that traverses across the flexible core 30 including two new knots 52 and corresponding traversing sections 54 located on each opposite side of the flexible core 30. As desired, another braided element can be formed by repeating the same braiding technique with the remaining portions of the lengths of braiding material. A number of braided elements may be formed in sequence to cover the entire length of the flexible core.

FIG. 7 also shows the flexible core 30 in dashed lines to provide an indication of how the flexible core is oriented, similar to FIG. 3 with respect to a partially completed braid pattern. FIG. 8 is the same as FIG. 7, but shows the flexible core 30 in solid lines to further illustrate how the flexible core is oriented, and the general positioning of the various parts of the lengths of material in terms of which parts reside on which side of the flexible core.

FIG. 9 represents a completed braid pattern in which the flexible core 30 is completely covered by the braid pattern, and the remaining lengths of the material 62 and 64 can be tied to one another with excess remaining material cut or tucked into the space between the braided material and the flexible core. As mentioned, in order to provide another plush toy feature to the invention, the flexible core may be first covered with a layer of fabric material (not shown), similar to a pillow case covering, in which one end of the fabric material is open to receive the flexible core, and then is sewn together to completely cover the flexible core. The braiding material may then be secured over the fabric material covering according to the desired braiding technique.

The invention provides a highly durable yet multifunctional pet toy. The flexible core provides bulk or size to the pet toy which enables an animal to chew on the pet toy and to generate sound with the integral squeaker. The braided fabric that covers the flexible core provides attributes of a plush toy which may be attractive to some animals who otherwise might not be attracted to a plastic or rubber chew toy. The features that may be attached to the braided material, such as appendages and a head, provide additional functionality for plush toy attributes, but also serve as aesthetic characteristics which may further stimulate the animal. The series or group of knots formed on the lateral side edges of the flexible core provide additional gripping capability for the animal for chewing purposes, or to improve the ability for the animal to manipulate and hold the pet toy with the animal's paws or mouth.

While the invention is described with respect to a preferred embodiment, it shall be understood that various modifications can be made to the invention commensurate with the scope of the claims appended hereto.

What is claimed is:

1. A pet toy comprising:
a flexible and resilient core having an interior space defining a chamber;
a noise making device disposed within the core;
a braided material covering the flexible core, the braided material including a plurality of knots and a plurality of traversing sections extending between the plurality of knots; and
at least one exterior feature secured to said braided material.

2. A pet toy, as claimed in claim 1, wherein:
said core is made of a thermoplastic elastomer or thermoplastic rubber that is flexible and resilient in response to a biting action from an animal on the core.

3. A pet toy, as claimed in claim 1, wherein:
said chamber defines a substantially cylindrical shaped opening through said core.

4. A pet toy, as claimed in claim 1, wherein:
said chamber has a substantially elliptical cross sectional shape.

5. A pet toy, as claimed in claim 1, wherein:
said noisemaking device is disposed within the core at one end thereof, and is at least partially encapsulated by material of said core at said one end, thereby providing protection for the noisemaking device from a biting action of an animal.

6. A pet toy, as claimed in claim 5, wherein:
an opening is formed within the core, and said opening communicates with said noisemaking device enabling a flow of air into and out from said chamber thereby enabling said noisemaking device to create sound as air also passes through said noisemaking device.

7. A pet toy, as claimed in claim 1, wherein:
said core extends along a longitudinal axis of said pet toy, said core having a length extending with said longitudinal axis, and further having a width extending transverse to said longitudinal axis.

8. A pet toy, as claimed in claim 7, wherein:
lateral side edges of said core extend along said longitudinal axis and substantially parallel to one another, and opposite ends of said core extend substantially perpendicular to said lateral side edges and along said with.

9. A pet toy, as claimed in claim 7, wherein:
said plurality of knots are oriented and aligned along both lateral side edges of said core, and said plurality of traversing sections extend between the plurality of knots transversely across the core along said width.

10. A pet toy, as claimed in claim 1, wherein:
said plurality of knots extends on lateral sides of the core in respective serial arrangements.

11. A pet toy, as claimed in claim 1, wherein:
said plurality of traversing sections extends transversely across the core between and substantially perpendicular to said lateral side edges.

12. A pet toy, as claimed in claim 1, wherein:
said braided material comprises two strands of fabric material braided along a length of said core to cover said core.

13. A pet toy comprising:
a flexible and resilient core having an interior space defining a chamber;
a noise making device disposed within the core:
a braided material covering the flexible core, the braided material including a plurality of knots and a plurality of traversing sections extending between the plurality of knots; and
wherein said noisemaking device is disposed within the core at one end thereof, and is at least partially encapsulated by material of said core at said one end, thereby providing protection for the noisemaking device from a biting action of an animal.

14. A pet toy, as claimed in claim 13, further including:
at least one exterior feature secured to said braided material.

15. A pet toy, as claimed in claim 13, wherein:
an opening is formed within the core, and said opening communicates with said noisemaking device enabling a flow of air into and out from said chamber thereby enabling said noisemaking device to create sound as air also passes through said noisemaking device.

16. A pet toy, as claimed in claim 13, wherein:
said plurality of knots are oriented and aligned along lateral side edges of said core, and said plurality of traversing sections extend between the plurality of knots transversely across the core.

17. A pet toy, as claimed in claim 13, wherein:
said plurality of knots extends on lateral sides of the core in respective serial arrangements.

18. A pet toy, as claimed in claim 13, wherein:
said plurality of traversing sections extends transversely across the core between and substantially perpendicular to opposite lateral side edges of the core.

19. A pet toy, as claimed in claim 13, wherein:
said braided material comprises two strands of fabric material braided along a length of said core to cover said core.

20. A pet toy, as claimed in claim 13, wherein:
said at least one exterior feature is sewn to said braided material, and said at least one exterior feature includes a depiction of at least one of a leg, an arm, a hand, a foot, or a head.
